(19) United States
(12) Patent Application Publication
(10) Pub. No.: US 2013/0127949 A1
(43) Pub. Date: May 23, 2013

(54) PRINTER AND PRINTHEAD MOVING MECHANISM

(71) Applicant: Seiko Epson Corporation, Tokyo (JP)

(72) Inventor: Tetsugo Ishida, Yamagata-mura (JP)

(73) Assignee: SEIKO EPSON CORPORATION, Tokyo (JP)

(21) Appl. No.: 13/681,959

(22) Filed: Nov. 20, 2012

(30) Foreign Application Priority Data
Nov. 21, 2011 (JP) 2011-253734

(51) Int. Cl. B41J 25/00

(52) U.S. Cl. CPC B41J 25/001
USPC 347/37

(57) ABSTRACT

The printhead moving mechanism of a printer has a carriage rotating mechanism that rotates a carriage around a support shaft disposed outside the platen, and a carriage positioning mechanism that moves the carriage vertically along the support shaft. The carriage rotating mechanism rotates the carriage between a printing position A, and a home position B rotated 90 degrees from the printing position A. The carriage positioning mechanism lowers the carriage toward the platen at the printing position A, and moves the carriage to an up position H2 separated from the platen in the area between an intermediate position C before the follower roller disposed on the upstream side of the printing position A and the home position B.

Priority is claimed under 35 U.S.C. 119 to Japanese patent application no. 2011-253734 filed on Nov. 21, 2011, which is hereby incorporated by reference in its entirety.

### BACKGROUND

1. Technical Field

The present invention relates to a printer and a printhead moving mechanism that causes the printhead to retract from the recording medium and move to and wait at a position separated from the recording medium.

2. Related Art

Serial inkjet printers print while moving the printhead back and forth widthwise relative to the recording medium. When printing ends, these printers move the printhead to a standby position beside the platen where the printhead waits for the next print job. A maintenance unit disposed below the standby position caps the nozzle face of the waiting printhead with a head cap to suppress ink evaporation, and performs maintenance operations such as forcibly ejecting ink into the head cap to eliminate clogged nozzles.

Line inkjet printers have a printhead with ink nozzles arrayed in a row of a width covering the entire print area of the recording medium, so that they can print without moving the printhead widthwise to the recording medium. Because the printhead is so wide, a large space equal to the width of the printhead is needed beside the platen in order to move the printhead widthwise to the recording medium and retract the printhead from above the platen. The printer width obviously also increases accordingly.

Japanese Unexamined Patent Appl. Pub. JP-A-2000-301710 describes a printer (inkjet printer) with a line printhead. This printer comprises a pivot shaft disposed to at a position separated from the recording medium, and one end of the printhead is supported rotatably on this shift. By pivoting the printhead on this shaft, the printhead is rotated 90 degrees and retracted from above the recording medium for printhead maintenance. The width of the space to which the printhead is retracted can therefore be reduced and overall printer width can be reduced.

While the width of the space occupied by the printhead when retracted from the platen can be reduced by pivoting the printhead on a shaft disposed at one end, the printhead pivots on the shaft through a fan-shaped space, and other parts must therefore be disposed outside this fan-shaped space to avoid interference with the printhead. For example, paper feed rollers can be disposed near the printing position in configurations in which the printhead only moves widthwise as described above, but the paper feed rollers must be separated a great distance from the printing position when the printhead pivots on a shaft so that the rollers do not intrude on this fan-shaped area of printhead movement. The media conveyance mechanism therefore occupies a larger space.

The printhead could conceivably pivot in the opposite direction so that the fan-shaped space of printhead movement is on the downstream side of the printing position, thereby avoiding interference with the paper feed roller on the upstream side, but because components such as a paper cutter are disposed on the downstream side, this requires changing the location of the paper cutter.

Because JP-A-2000-301710 does not consider interference between the printhead and other parts such as the paper feed rollers disposed above the recording medium, such parts must be moved from the area of printhead travel, and space for these parts must be provided elsewhere. The media conveyance mechanism therefore occupies a larger space, and printer size increases accordingly. Printing precision also decreases because moving the paper feed rollers away from the printing position allows the recording medium to separate more from the platen at the printing position.

### SUMMARY

A printhead moving mechanism and a printer having a printhead moving mechanism according to the present invention causes a carriage carrying the printhead to pivot at one end while allowing a paper feed roller to be disposed in the range of carriage movement.

A printhead moving mechanism that moves a carriage carrying a printhead between a printing position opposite a recording medium and retracted position that is different from the printing position according to one aspect of at least one embodiment of the invention has a carriage rotating unit that rotates the carriage around one end of the carriage extended outside the recording medium at a position in the conveyance direction of the recording medium on the downstream side or upstream side of a conveyance roller that conveys the recording medium; and a carriage positioning unit that moves the carriage to and away from the recording medium conveyance surface. The carriage is positioned on either the upstream side or the downstream side of the conveyance roller when at the printing position, and the carriage positioning unit separates the carriage from the recording medium conveyance surface according to the rotational position of the carriage, and moves the carriage to a position not interfering with the conveyance roller.

This aspect of the invention can avoid interference between the carriage and printhead and the conveyance roller even when the conveyance roller is located close to the printing position because the carriage can be moved away from the recording medium conveyance surface to a position not interfering with the conveyance roller. Moving the conveyance roller disposed on the upstream side of the printing position to a position separated from the printing position is therefore not necessary, and the print mechanism and conveyance mechanism can be located together in a confined space. The carriage and printhead can also be moved from a transverse position when in the printing position to a longitudinal position in the retracted position by pivoting the carriage on one end thereof. By thus narrowing the width of the space to which the carriage and printhead are retracted, the width of the printer can also be reduced. Reducing the size of this retraction space therefore helps to both reduce overall device width and dispose the print mechanism and conveyance mechanism close together, and effectively reduces device size.

In addition, by disposing the conveyance roller close to the printing position, the recording medium can be prevented from lifting away from the platen at the printing position, and a drop in printing precision can be suppressed.

Further preferably in a printhead moving mechanism according to another aspect of at least one embodiment of the invention, the carriage rotating unit rotates the carriage on the end of the carriage positioned on the downstream side of the conveyance roller; at the printing position, the other end of the carriage is positioned on the downstream side of the conveyance roller; and at the retracted position, the other end of the carriage is positioned on the upstream side or the downstream side of the conveyance roller.

Yet further preferably, the carriage positioning unit moves the carriage bidirectionally along the axis of rotation of the carriage. Because the shaft on which the carriage rotates is also used as a guide shaft for positioning the carriage, the configuration of the carriage rotating unit and the carriage positioning unit can be simplified.

Yet further preferably, the retracted position is a position removed to the outside of the recording medium, or a position removed to the upstream side or downstream side of the conveyance roller.

In another aspect of the invention, the retracted position is a position where the printhead is opposite a maintenance unit disposed outside the recording medium.

These configurations enable printhead maintenance to be performed at the retracted position.

Further preferably in another aspect of at least one embodiment of the invention, the retracted position is a position where the carriage is separated from the recording medium conveyance surface to a position not interfering with the conveyance roller, and printhead maintenance can be performed without lowering the printhead positioned at the retracted position to the maintenance unit. As a result, after raising the carriage away from the recording medium conveyance surface to avoid interference with the conveyance roller, there is no need to lower the carriage again to the conveyance surface at the retracted position for maintenance. There is also no need to raise the carriage again to return from the retracted position to the printing position. The time required to retract the carriage, and the time required to return the carriage to the printing position, can therefore be shortened.

Another aspect of at least one embodiment of the invention is a printer having the printhead moving mechanism described above; a printhead that can eject ink from one end to the other end of the width of the print area of the recording medium at the printing position; a carriage that carries the printhead and is moved by the printhead moving mechanism between the printing position and the retracted position; a conveyance roller that conveys the recording medium through a conveyance path past the printing position; and a maintenance unit that performs maintenance on the printhead moved to the retracted position.

### Effect of the Invention

At least one embodiment of the invention can move the carriage away from the recording medium conveyance surface to a position that does not interfere with the conveyance roller, and can avoid interference between the carriage and printhead and the conveyance roller. The print mechanism and conveyance mechanism can therefore be located together in a confined space. The carriage and printhead can also be moved from a transverse position when in the printing position to a longitudinal position in the retracted position, and the width of the space to which the carriage and printhead are retracted can be reduced. Reducing the size of this retraction space therefore helps to both reduce overall device width and dispose the print mechanism and conveyance mechanism close together, and effectively reduces device size.

In addition, by disposing the conveyance roller close to the printing position, the recording medium can be prevented from lifting at the printing position, and a drop in printing precision can be suppressed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a vertical section view showing the overall configuration of a printer according to a preferred embodiment of the invention.

FIGS. 2A and 2B are plan views and a side view of the printhead moving mechanism.

FIGS. 3A and 3B show the pivot position and the vertical position of the carriage when rotated to the printing position.

FIGS. 4A and 4B show the pivot position and the vertical position of the carriage at an intermediate position.

FIGS. 5A and 5B show the pivot position and the vertical position of the carriage when rotated to the home position.

### DESCRIPTION OF EMBODIMENTS

Preferred embodiments of a printer and a printhead moving mechanism according to the present invention are described below with reference to the accompanying figures.

### General Configuration

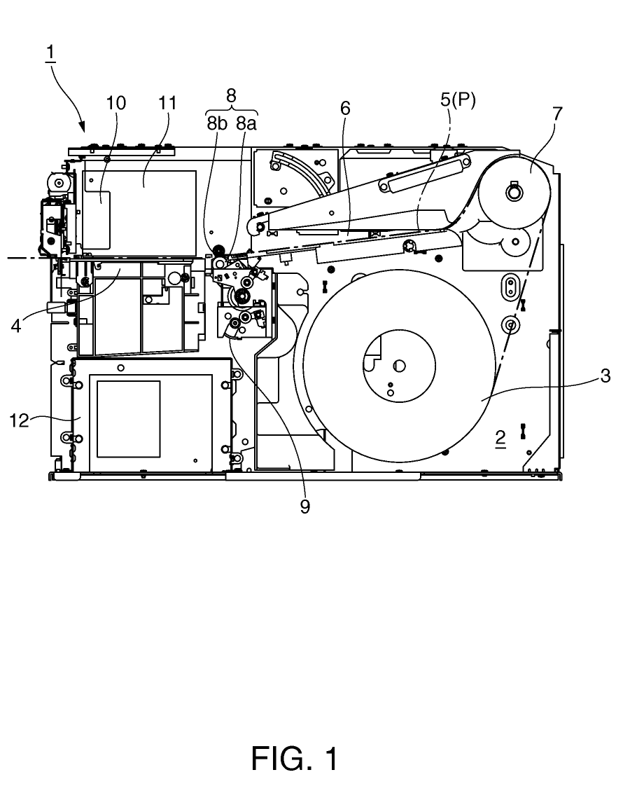

FIG. 1 is a vertical section view showing the general configuration of an inkjet printer 1 (printer 1 below) according to this embodiment of the invention. This printer 1 prints to a continuous web of recording paper P using plural colors of ink. A roll paper compartment 2 is located at the back part of the printer 1. Recording paper P pulled from a paper roll 3 held in the roll paper compartment 2 is conveyed to the front of the printer through a recording paper conveyance path 5 over the surface of a platen 4 disposed in front of the roll paper compartment 2.

A paper guide 6 for preventing skewing of the recording paper P is disposed above the roll paper compartment 2, and a supply roller 7 for pulling the recording paper P from the paper roll 3 is located behind the paper guide 6. The recording paper P is pulled from the paper roll 3 at an angle to the back towards the supply roller 7, and then winds around the supply roller 7. After being pulled forward around the supply roller 7, the recording paper P passes a load roller not shown disposed behind the paper guide 6, passes over the paper guide 6 and through the paper feed roller pair 8 located in front of the paper guide 6, and then passes over the surface of the platen 4. The paper feed roller pair 8 includes a drive roller 8a that contacts the recording paper P from below, and a follower roller 8b (conveyance roller) that is urged from above to the drive roller 8a side. A paper feed motor 9 that rotates the drive roller 8a forward and reverse is disposed below the paper feed roller pair 8. A conveyance unit for conveying the recording paper P forward and reverse through the paper conveyance path 5 includes the supply roller 7, paper feed roller pair 8, and paper feed motor 9.

An inkjet head 11 (printhead) is mounted on a carriage 10 above the platen 4. An ink cartridge unit 12 is disposed below the platen 4. Ink cartridges storing four colors of ink, cyan, magenta, yellow, and black, are loaded in the ink cartridge unit 12. When an ink cartridge is loaded in the ink cartridge unit 12, a pump mechanism not shown for supplying ink is connected to an ink tank inside the ink cartridge through an ink supply tube (not shown in the figure), and ink can be supplied to the inkjet head 11.

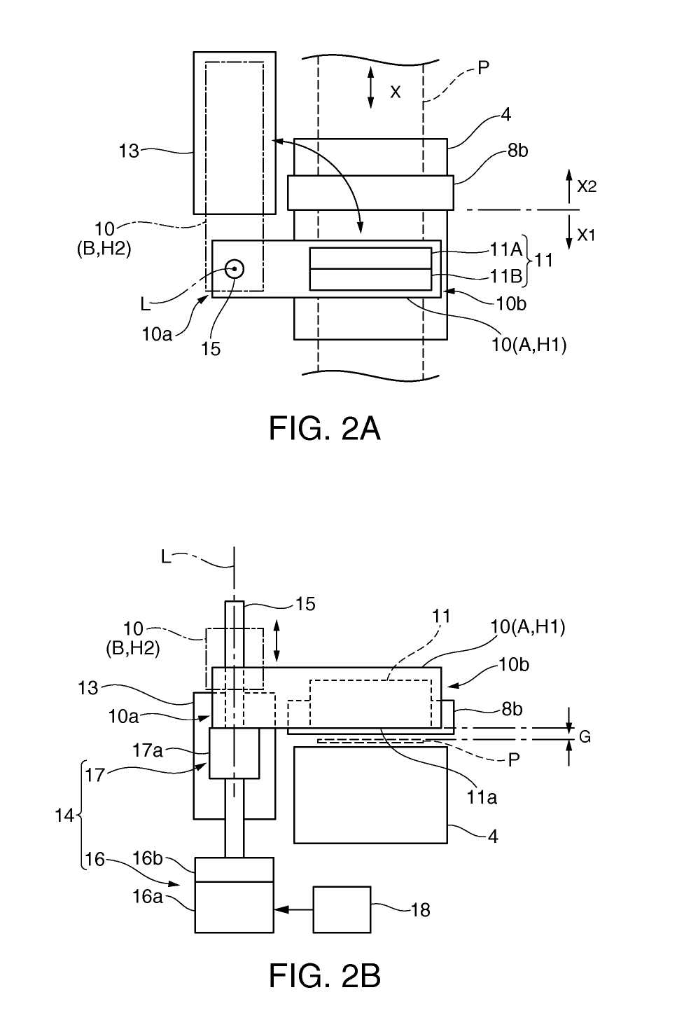

FIGS. 2A AND 2B describe the printhead moving mechanism, FIG. 2A being a plan view and FIG. 2B being a side view from the front of the printer. As shown in FIG. 2A, the inkjet head 11 is a compound head including a first head 11A and a second head 11B. The first head 11A has ink nozzle rows that eject black and cyan ink, and second head 11B has ink nozzle rows that eject yellow and magenta ink. The first and second heads 11A, 11B are wider than the recording paper P, and the ink nozzle rows of each head are formed through an area with a width sufficient to cover the entire print area on the recording paper P.

A maintenance unit 13 is disposed beside the platen 4. The carriage 10 moves the inkjet head 11 bidirectionally through an area from the printing position A above the platen 4 to a home position B (retracted position) above the maintenance unit 13. When in the printing position A, the inkjet head 11 and carriage 10 extend horizontally with the long side thereof in a direction perpendicular to the conveyance direction X of the recording paper P, and each of the ink nozzle rows in the first and second heads 11A, 11B cover the print area of the recording paper P. In the home position B, the inkjet head 11 and carriage 10 have pivoted 90 degrees from the printing position A, and are positioned longitudinally parallel to the conveyance direction X.

As shown in FIG. 2B, the ink jet head is mounted on the carriage 10 with the ink nozzle face 11a facing down. The carriage 10 holds the inkjet head 11 at a height at which a platen gap G of a preset dimension is formed between the ink nozzle face 11a of each printhead and the recording paper P on the surface of the platen 4.

The printer 1 prints on the recording paper P by positioning and stopping the inkjet head 11 at the printing position A, and then ejecting ink while advancing the recording paper P in increments of a specific pitch. When printing ends, the printer 1 retracts the inkjet head 11 to the home position B separated from the platen 4 and waits with the inkjet head 11 in the home position B. While waiting, the printer 1 also operates a maintenance unit 13 to prevent or eliminate clogging of the ink nozzles in the inkjet head 11. More specifically, the head cap at the top of the maintenance unit 13 rises to cap the ink nozzle face 11a, and an ink ejection operation that ejects ink into the head cap or an ink suction operation that suctions ink from the head cap side is performed as needed. Alternatively, the maintenance unit 13 could have a wiper mechanism to wipe the ink nozzle face 11a as needed. When printing resumes, the head cap and wiping mechanism are lowered away from the ink nozzle face 11a, and the inkjet head 11 is moved to the printing position A.

### Printhead Moving Mechanism

The printer 1 has a printhead moving mechanism 14 that moves the inkjet head 11 and the carriage 10 carrying the inkjet head 11 bidirectionally between the printing position A and the home position B. As shown in FIG. 2A, the one end 10a of the carriage 10 extends outside the width of the platen 4, and a support shaft 15 is attached to this end 10a. The center axis L (axis of rotation) of the support shaft 15 is perpendicular to the ink nozzle face 11a of the inkjet head 11, and the carriage 10 can slide vertically along the support shaft 15. The printhead moving mechanism 14 includes a carriage rotating mechanism 16 (carriage rotating unit) that rotates the carriage 10 on the support shaft 15, and a carriage positioning mechanism 17 (carriage positioning unit) that moves the carriage 10 vertically along the support shaft 15.

The carriage rotating mechanism 16 includes a carriage motor 16a, and a speed reducer 16b that slows and transfers rotation of the carriage motor 16a output shaft to the support shaft 15. By controlling operation of the carriage motor 16a, the control unit 18 of the printer 1 moves the carriage 10 between the printing position A and the home position B at a position rotated 90 degrees counterclockwise from the printing position A, and can stop the carriage 10 at any rotational position within this range of rotation. Because the carriage 10 is positioned transversely as described above at the printing position A, the entire carriage 10, including the distal end 10b of the carriage farthest from the support shaft 15, is positioned downstream from the follower roller 8b (the side in the direction of arrow X1 in FIG. 2A). Because the carriage 10 is disposed longitudinally when in the home position B, the end 10a on which the carriage 10 pivots is on the downstream side of the follower roller 8b, and the distal end 10b is on the upstream side of the follower roller 8b (the side in the direction of arrow X2 in FIG. 2A).

The carriage positioning mechanism 17 includes a conversion mechanism 17a that converts rotation of the output shaft of the carriage motor 16a or rotation of the support shaft 15 to the reciprocating linear movement of the carriage 10 along the support shaft 15. The conversion mechanism 17a could be a cam mechanism disposed between the carriage 10 and support shaft 15, for example, or other type of mechanism that converts rotational movement to linear movement. When the carriage 10 is raised along the support shaft 15 by the carriage positioning mechanism 17, the carriage 10 and the inkjet head 11 mounted thereon move in the direction away from the surface of the platen 4 (that is, the recording paper P conveyance surface). When the carriage 10 descends along the support shaft 15, the carriage 10 and the inkjet head 11 mounted thereon move in the direction approaching the surface of the platen 4. In this embodiment, the carriage rotating mechanism 16 and the carriage positioning mechanism 17 are driven by the same carriage motor 16a, and the rotational position and the vertical position of the carriage 10 change together based on the output rotation of the carriage motor 16a.

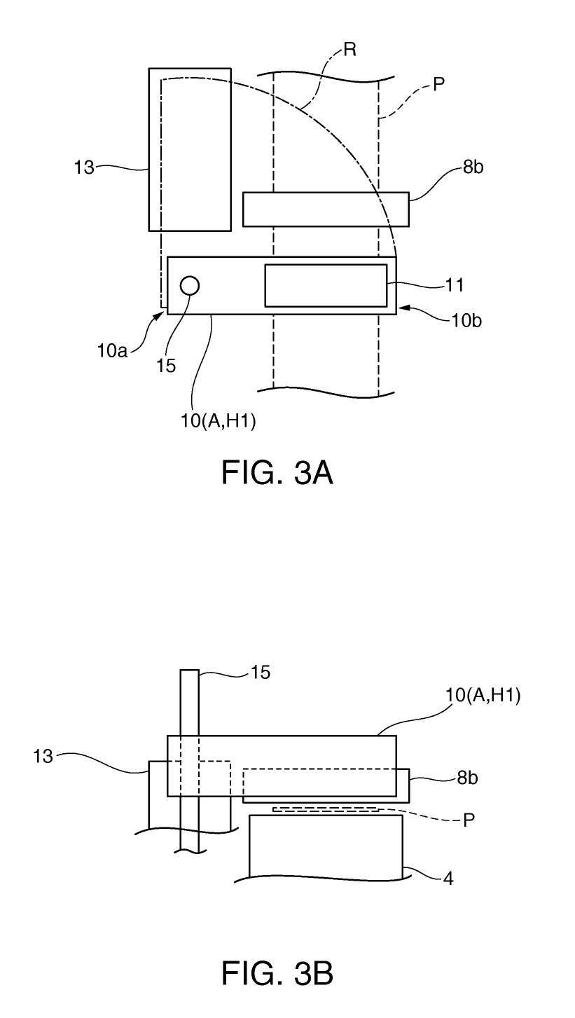

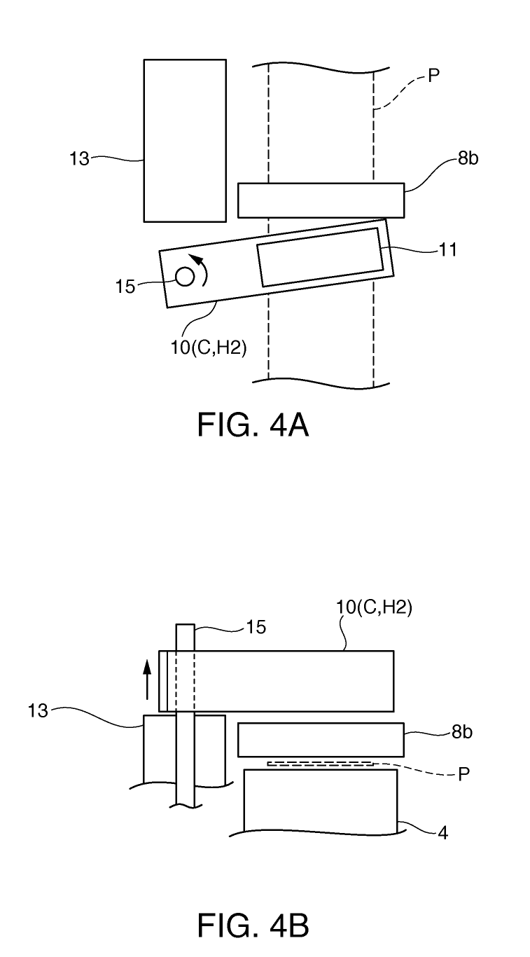

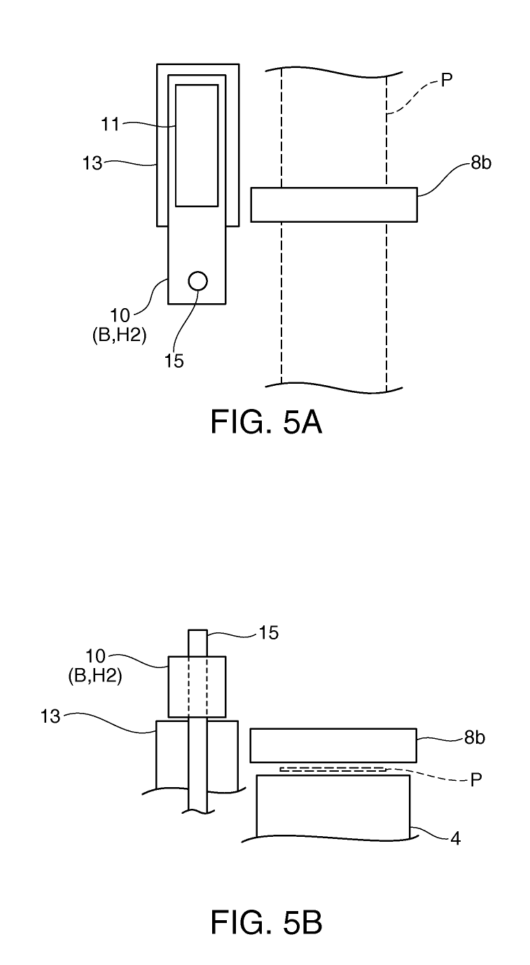

FIG. 3A to FIG. 5B describe the rotational position and the vertical position of the carriage, FIG. 3A and FIG. 3B show the carriage at the printing position A, FIG. 4A and FIG. 4B show the carriage at an intermediate position C, and FIG. 5A and FIG. 5B show the carriage at the home position B. FIG. 3A, FIG. 4A, and FIG. 5A are plan views, and FIG. 3B, FIG. 4B, and FIG. 5B are side views.

As shown in FIG. 3A and FIG. 3B, the carriage positioning mechanism 17 has lowered the carriage 10 to the position closest to the platen 4 when the carriage 10 is in the printing position A. The down position H1 of the carriage 10 in the printing position A is set to the height forming the platen gap G suitable for printing between the ink nozzle face 11a of the inkjet head 11 on the carriage 10 and the surface of the recording paper P passing over the surface of the platen 4.

The carriage positioning mechanism 17 raises the carriage 10 to an up position H2 that is higher than the printing position A before the carriage 10 rotates to the intermediate position C before the follower roller 8b as shown in FIG. 4A. This up position H2 is set to a height where the carriage 10 and the inkjet head 11 mounted thereon are above the follower roller 8b.

As shown in FIGS. 5A and 5B, the height of the carriage 10 at the home position B is the same as the up position H2 reached at the intermediate position C.

The carriage rotating mechanism 16 and carriage positioning mechanism 17 of the printhead moving mechanism 14 rotate and move the carriage 10 between the down position H1 and up position H2 in the range of movement between the printing position A and the intermediate position C, and rotate the carriage 10 between the intermediate position C and the home position B while keeping the height of the carriage 10 at the up position H2.

As shown in FIG. 3A, the range of movement R of the carriage 10 and the inkjet head 11 mounted thereon when moving between the printing position A and home position B is a fan-shaped space around the end 10a of the carriage 10 where the support shaft 15 is disposed. The follower roller 8b is located at a position inside this fan-shaped range of movement R when seen in plan view. As a result, if the carriage 10 moves between the printing position A and home position B without moving vertically, the carriage 10 and inkjet head 11 will interfere with the follower roller 8b thereby pushing down on the recording paper P.

However, the printhead moving mechanism 14 in this embodiment of the invention moves the carriage 10 and inkjet head 11 to a height where there is no interference with the follower roller 8b when moved to a position superimposed on the follower roller 8b in plan view. Interference between the carriage 10 and inkjet head 11 and the follower roller 8b can therefore be avoided even when the follower roller 8b is disposed in this range of movement R.

The home position B is above the maintenance unit 13 disposed beside the platen 4, but the maintenance unit 13 in the printer according to this embodiment of the invention is disposed at a height where maintenance can be performed at the home position B on the inkjet head 11 supported on the carriage 10 at the up position H2 without lowering the inkjet head 11. More specifically, the maintenance unit 13 can cap the ink nozzle face 11a and eject ink or suction ink without moving the inkjet head 11 from the up position H2.

As described above, the printer 1 according to this embodiment of the invention can avoid interference between the carriage 10 and inkjet head 11 and the follower roller 8b by moving the carriage 10 away from the platen 4 to a position where there is no interference with the follower roller 8b. The print mechanism and the paper feed mechanism can therefore be disposed together in a confined space. The width of the space to which the carriage 10 and inkjet head 11 are retracted can also be reduced by moving the carriage 10 and inkjet head 11 from a transverse position when in the printing position A to a longitudinal position in the home position B. Reducing the size of this retraction space therefore helps to both reduce the width of the printer 1 and dispose the print mechanism and paper feed mechanism close together, and effectively reduces the size of the printer 1. Yet further, by disposing the follower roller 8b close to the printing position A, the recording paper P can be prevented from lifting away from the platen at the printing position A. A drop in printing precision can therefore be suppressed.

After raising the carriage 10 away from the platen 4 to avoid interference with the follower roller 8b in this embodiment of the invention, there is no need to lower the carriage 10 again at the home position B for maintenance. There is also no need to raise the carriage 10 again for movement from the home position B to the printing position A. The time required to retract the carriage 10, and the time required to return the carriage 10 to the printing position A, can therefore be shortened.

### Other Embodiments

(1) The carriage 10 is rotated 90 degrees at the home position B in the foregoing embodiment, but the carriage 10 can be rotated to any appropriate angle at the home position B. In this case, the position of the maintenance unit 13 is adjusted according to the change in the angle of the home position B. Space inside the printer 1 can be used efficiently by thus setting the home position B to an angle appropriate to the internal configuration of the printer 1. Greatly changing the configuration of the printhead moving mechanism 14 is also not necessary in order to change the angle of the home position B.

(2) The embodiment described above is configured to avoid interference with the follower roller 8b located on the upstream side of the printing position A when the carriage 10 rotates to the upstream side, and can also be configured to avoid interference with paper feed rollers, paper guide members, and other parts on the downstream side if the carriage 10 rotates to the downstream side.

(3) The carriage rotating mechanism 16 and carriage positioning mechanism 17 are driven by a common carriage motor 16a in the embodiment described above, but could be driven by different power sources. In this case, the separate drive mechanisms are controlled to cooperatively adjust the height of the carriage according to the rotational position. When the carriage rotating mechanism 16 and carriage positioning mechanism 17 are driven by separate power sources, the carriage 10 can also be rotated and moved vertically at different times. The carriage 10 can therefore be raised before starting to rotate, and can be rotated after the carriage 10 rises to the up position H2 at the printing position A. The height of the inkjet head 11 can also be precisely adjusted at the printing position A and the home position B.

(4) The carriage 10 is held at the up position H2 height when moving from the intermediate position C to the home position B in the embodiment described above, but the carriage 10 can be moved vertically as desired in the range that avoids interference with the follower roller 8b. For example, the carriage 10 could be set to a higher position than the up position H2 at the home position B. This enables setting the maintenance unit 13 to a higher position.

(5) The carriage positioning mechanism 17 is configured in the above embodiment to move the carriage 10 vertically along the axis of rotation L, but parts can be arranged more freely by setting the direction of movement to and away from the platen 4 as desired. For example, if the carriage 10 and the support shaft 15 move together, the carriage 10 can be configured to move vertically while moving downstream or upstream in the conveyance direction (that is, moving bidirectionally in a direction inclined downstream or upstream to the axis of rotation L). In this configuration the home position B can be shifted downstream or upstream. The position of the maintenance unit 13 can also be determined more freely.

The invention being thus described, it will be apparent that it may be varied in many ways. Such variations are not to be regarded as a departure from the spirit and scope of the invention, and all such modifications as would be known to one skilled in the art are intended to be included within the scope of the following claims.

What is claimed is:

1. A printhead moving mechanism that moves a carriage carrying a printhead between a printing position opposite a recording medium and a retracted position that is different from the printing position, comprising:
a carriage rotating unit that rotates the carriage at a point located outside a width of the recording medium; and
a carriage positioning unit that moves the carriage to and away from the recording medium conveyance surface;
wherein the carriage is positioned on one of an upstream side and a downstream side of a conveyance roller that conveys the recording medium when at the printing position, and
the carriage positioning unit separates the carriage from a recording medium conveyance surface according to the rotational position of the carriage, and moves the carriage to a position at which the carriage does not interfere with the conveyance roller.

2. The printhead moving mechanism described in claim 1, wherein: when the carriage is in the retracted position the carriage is positioned outside the width of the recording medium.

3. The printhead moving mechanism described in claim 1, wherein:
the retracted position is set to a location removed to one of the upstream side and the downstream side of the conveyance roller.

4. The printhead moving mechanism described in claim 1, wherein:
the point is positioned on the downstream side of the conveyance roller;
at the printing position, the other end of the carriage is positioned on the downstream side of the conveyance roller; and
at the retracted position, the other end of the carriage is positioned on the upstream side of the conveyance roller.

5. The printhead moving mechanism described in claim 1, wherein:
the carriage positioning unit moves the carriage bidirectionally along an axis of rotation of the carriage.

6. The printhead moving mechanism described in claim 1, wherein:
the retracted position is a position where the printhead is opposite a maintenance unit disposed outside the recording medium.

7. The printhead moving mechanism described in claim 6, wherein:
the retracted position is a position where the carriage is separated from the recording medium conveyance surface to a position not interfering with the conveyance roller, and printhead maintenance can be performed without lowering the printhead positioned to the retracted position to the maintenance unit.

8. A printer comprising:
the printhead moving mechanism described claim 1;
a printhead that can eject ink from a first end to a second end of a width of a print area of the recording medium at the printing position;
a carriage that carries the printhead and is moved by the printhead moving mechanism between the printing position and the retracted position; and
a maintenance unit that maintains the printhead at to the retracted position.

9. A printer comprising:
the printhead moving mechanism described claim 2;
a printhead that can eject ink from a first end to a second end of a width of a print area of the recording medium at the printing position;
a carriage that carries the printhead and is moved by the printhead moving mechanism between the printing position and the retracted position; and
a maintenance unit that maintains the printhead at to the retracted position.

10. A printer comprising:
the printhead moving mechanism described claim 3;
a printhead that can eject ink from a first end to a second end of a width of a print area of the recording medium at the printing position;
a carriage that carries the printhead and is moved by the printhead moving mechanism between the printing position and the retracted position; and
a maintenance unit that maintains the printhead at to the retracted position.

11. A printer comprising:
the printhead moving mechanism described claim 4;
a printhead that can eject ink from a first end to a second end of a width of a print area of the recording medium at the printing position;
a carriage that carries the printhead and is moved by the printhead moving mechanism between the printing position and the retracted position; and
a maintenance unit that maintains the printhead at to the retracted position.

12. A printer comprising:
the printhead moving mechanism described claim 5;
a printhead that can eject ink from a first end to a second end of a width of a print area of the recording medium at the printing position;
a carriage that carries the printhead and is moved by the printhead moving mechanism between the printing position and the retracted position; and
a maintenance unit that maintains the printhead at to the retracted position.
